(19) United States
(12) Patent Application Publication
(10) Pub. No.: US 2016/0119507 A1
(43) Pub. Date: Apr. 28, 2016

(54) SYNCHRONIZED MEDIA SERVERS AND PROJECTORS

(71) Applicant: Barco, Inc., Rancho Cordova, CA (US)

(72) Inventors: Diego Duyvejonck, Kuurne (BE); Jérôme Delvaux, Kuurne (BE); Alexander William Gocke, Rancho Cordova, CA (US); Emmanuel Cappon, Kuurne (BE); Scott Stremple, Rancho Cordova, CA (US)

(21) Appl. No.: 14/867,559

(22) Filed: Sep. 28, 2015

Related U.S. Application Data
(60) Provisional application No. 62/069,720, filed on Oct. 28, 2014.

(51) Int. Cl. H04N 5/04; H04N 13/04; H04N 9/31

(52) U.S. Cl. CPC H04N 5/04; H04N 9/3179; H04N 13/0459; H04N 13/0497

(57) ABSTRACT

An immersive display system is disclosed. The immersive display system includes a master projector system and a plurality of slave projector systems. The master projector system synchronizes the display of a video with the plurality of slave projector systems using a synchronization signal. The synchronization signal is sequentially transmitted from the master projector system to each of the slave projector systems, wherein the projector systems are serially connected to one another. Sub-frame video synchronization is achieved using the sequentially chained projector systems.

### CROSS-REFERENCE TO RELATED APPLICATIONS

This application claims the benefit of priority to U.S. Prov. App. No. 62/069,270, filed Oct. 28, 2014, entitled “Synchronized Media Servers and Projectors,” the entirety of which is incorporated herein by reference.

### BACKGROUND

1. Field

The present disclosure generally relates to distributed projector systems that provide synchronized videos projected onto a plurality of screens.

2. Description of Related Art

Digital cinema servers and projectors receive digital content for projection in a theater or other venue. The content can be packaged in one or more digital files for delivery and storage on a media server. The media server can then extract the digital content from the one or more digital files for display using one or more projectors. In some cases, the content can be 3D video projected onto a screen where slightly different visual content is projected for simultaneous observation in the right and left eyes of a viewer to create the illusion of depth. A multi-projection system can be used to display video on a plurality of screens in a venue, such as in a theater or auditorium, to facilitate an immersive experience for the viewer.

### SUMMARY

Example embodiments described herein have innovative features, no single one of which is indispensable or solely responsible for their desirable attributes. Without limiting the scope of the claims, some of the advantageous features will now be summarized.

An immersive display system can include a plurality of projection systems arranged to provide immersive viewing of video. Such an immersive display system can include a plurality of projector systems that each projects video wherein video frames from each video are synchronized with one another. Each projector system can be configured to project its video onto a projection surface placed around an audience. In this way, the audience can experience a sense of immersion into the environment depicted in the video. Synchronized video provided by the plurality of projector systems may be projected on the plurality of projection surfaces creating a unified video presentation. Such immersive display systems are capable of generating audiovisual presentations with a relatively high level of realism due at least in part to video being simultaneously presented to the viewer from many directions.

Typically, movie theaters provide a single screen for viewing projected video content. The video content can be digitally stored as a package of digital files on a media server that the media server decodes to provide to the projector. However, such single-screen projector systems are not configured to provide multi-view content (e.g., media streams designed to be projected onto a plurality of screens). Combining a plurality of such single-screen projector systems to enable presentation of multi-view content to create an immersive display system presents a number of challenges. For example, to provide an immersive audiovisual environment it can be important to reduce or eliminate issues that may destroy the immersive quality of the experience for the viewer. In particular, if video from different projectors are not synchronized, a viewer may become disoriented, distracted, or may otherwise lose a sense of immersion in the environment. Combining single-screen projector systems can result in video synchronization issues because such projector systems may not be configured to synchronize video with other projector systems. Thus, attempts to convert single-screen projector systems to be part of an immersive display system may result in out-of-sync video on different screens, reducing viewer enjoyment and satisfaction.

Accordingly, systems and methods are provided herein for providing synchronized media streams from a plurality of projector systems. In particular, a master projector system can generate a synchronization signal based at least in part on the media stream provided by the master projector system and transmit the synchronization signal serially to a plurality of slave projector systems (e.g., creating a chain of projector systems). In succession, each slave projector system in the chain receiving the synchronization signal can (1) pass the signal to a subsequent slave projector system and (2) process the synchronization signal to determine when to display a video frame so that it is synchronized with the video of the master projector system. The projector systems can thus be connected in serial, or chained together, to synchronize the media streams of each, the synchronization signal being provided by the master projector system.

In some implementations, an immersive display system comprises at least 3 screens with at least 3 sequentially chained projector systems. Digital media content can be downloaded to each projector system, the projector system comprising a media server and a projector wherein the media server drives the projector. A master projector system creates and transmits a synchronization signal to enable synchronous projection of video content by all projector systems with sub-frame accuracy. The synchronization signal gets passed sequentially among the at least 3 chained projector systems.

Advantageously, a sequentially chained projector system can utilize a simple wired connection (e.g., a coaxial cable between projector systems) to transmit a synchronization signal derived from standard timecodes used in media environments. Using sequentially chained projector systems can also simplify the generation and transmission of the synchronization signal. For example, the serial connection design may reduce or eliminate the need for signal amplification relative to an immersive display system employing a parallel connection infrastructure. Similarly, the serial connection design reduces or eliminates a need for a centralized distribution system to distribute the synchronization signal to each projector system relative to an immersive display system employing a parallel connection infrastructure. Moreover, the serial connection design enables flexibility in the number of projector systems in the immersive display system because the addition of another projector system simply entails adding another link in the projector system chain. This may provide an advantage over a parallel connection design as a maximum number of projector systems may be reached in a parallel system when the synchronization signal distribution system runs out of available physical connection points. The serial connection design also can result in relatively small latency between projector systems. The synchronization signal may also enable synchronization of video with different frame rates, aspect ratios, codecs, or the like due at least in part to the synchronization signal being independent of these parameters. For example, a master projector system can generate a synchronization signal based at least in part on a signal coming from its framebuffer and a slave projector system can synchronize its video based at least in part on regulating the signal output of its framebuffer according to information in the synchronization signal.

In some implementations, multi-view content can be packaged for digital delivery and ingestion by a media server, wherein the package comprises a plurality of channels of video to be displayed by a corresponding plurality of projector systems. In some embodiments, each of the video channels can conform to standard digital content packaging formats (e.g., such as standards set by Digital Cinema Initiatives, LLC, or DCI). A master projector system comprising a master server can ingest the package, extract the digital files, and distribute the video channels to other slave projector systems. In some embodiments, the master projector system can selectively distribute video data to the projector system intended to play the video data. In some embodiments, each projector system in the immersive display system ingests the entire package and is configured to determine the appropriate video channel to decode and display. In some embodiments, the master server is configured to automatically determine the appropriate slave projector system for each video channel in the package and to transmit the video channel data to the slave projector system, where transmission can occur prior to presentation of the multi-view content, during playback wherein the slave projector system buffers the video channel data, or the video channel data is delivered and displayed in real-time.

In some embodiments, the master projector system includes hardware and/or software components that distinguish it from slave projector systems. For example, a slave projector system can include a synchronization module or card that allows it to frame-lock the video presentation based at least in part on the synchronization signal originating from the master projector system. In some embodiments, the master projector system and slave projector system contain the same hardware and/or software components but the master projector system is configured to act as the master while other projector systems are configured to act as slaves. In some embodiments, a projector system comprises a media server and projector integrated into a single physical unit. In some embodiments, a projector system comprises a media server and a projector that are physically separate and communicatively coupled to one another (e.g., through a wired or wireless connection).

### BRIEF DESCRIPTION OF THE DRAWINGS

Various embodiments are depicted in the accompanying drawings for illustrative purposes, and should in no way be interpreted as limiting the scope of the inventions. In addition, various features of different disclosed embodiments can be combined to form additional embodiments, which are part of this disclosure. Any feature or structure can be removed or omitted. Throughout the drawings, reference numbers can be reused to indicate correspondence between reference elements.

FIG. 1 illustrates an example immersive display system for providing an immersive display experience.

FIG. 2 illustrates a plurality of example projector systems ingesting digital content for display.

FIG. 3 illustrates a plurality of example projector systems displaying synchronized video.

FIG. 4 illustrates a block diagram of an example media server system.

FIG. 5 illustrates a slave media server receiving a synchronization signal and transmitting the synchronization signal to the next slave media server in the chain.

FIG. 6 illustrates an example media server module configured to allow a projector system to be upgraded from a single-screen projector system to projector system that can part of an immersive display system.

FIG. 7 illustrates a flow chart of an example method of synchronizing multiple media streams in serially connected media servers in an immersive display system.

FIG. 8 illustrates a flow chart of an example method of synchronizing a slave video with a master video based at least in part on a synchronization signal from a master projector system.

FIG. 9 illustrates an example immersive display system for providing an immersive display experience with control connections between projector systems and content lines connecting the projector systems to a server.

### DETAILED DESCRIPTION

Although certain embodiments and examples are disclosed herein, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process can be performed in any suitable sequence and are not necessarily limited to any particular disclosed sequence. Various operations can be described as multiple discrete operations in turn, in a manner that can be helpful in understanding certain embodiments; however, the order of description should not be construed to imply that these operations are order dependent. Additionally, the structures described herein can be embodied as integrated components or as separate components. For purposes of comparing various embodiments, certain aspects and advantages of these embodiments are described. Not necessarily all such aspects or advantages are achieved by any particular embodiment. Thus, for example, various embodiments can be carried out in a manner that achieves or optimizes one advantage or group of advantages as taught herein without necessarily achieving other aspects or advantages as can also be taught or suggested herein.

### Immersive Display System

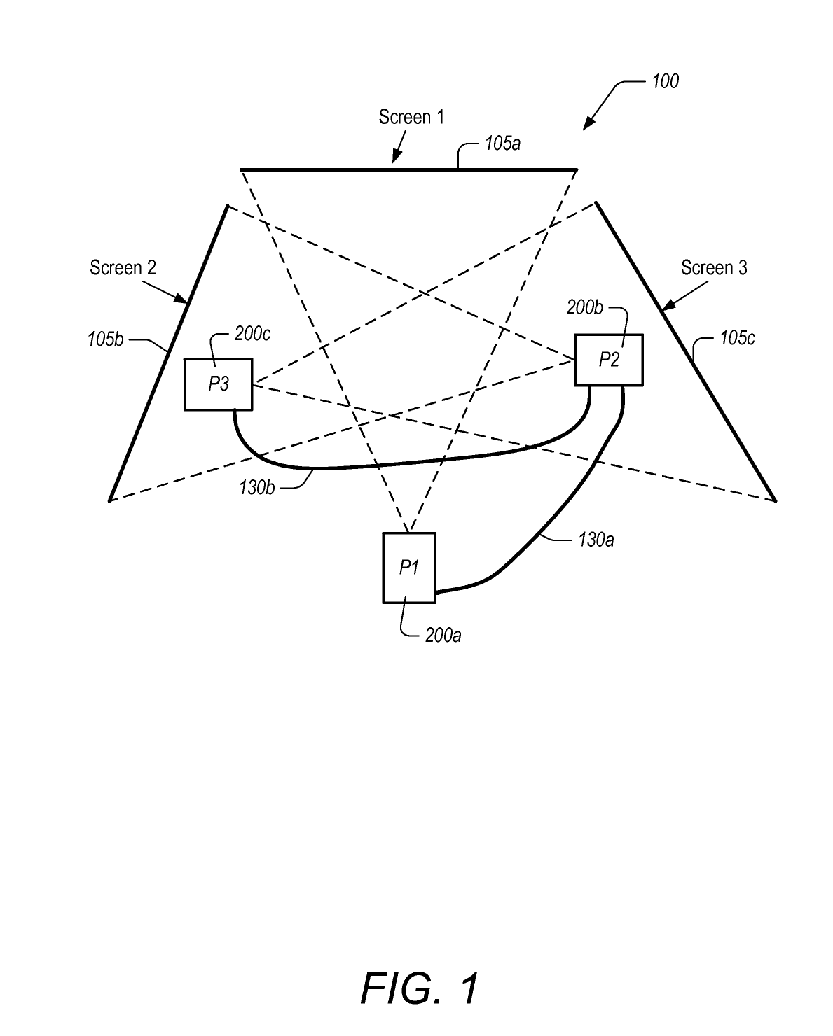

FIG. 1 illustrates an example immersive display system 100 comprising a plurality of projectors, 200a-c, configured to project images onto corresponding screens 105a-c for providing an immersive display experience. The immersive display system 100 can include, for example and without limitation, multiple direct-view displays, multiple rear-projection displays, and/or multiple front-projection displays, such as screens 105a-c. There can be gaps between adjacent displays. For example, screens 105a-c can have gaps between them as depicted in FIG. 1. In some embodiments, the gaps can be relatively small, close to zero, or zero. The immersive display system 100 can include a plurality of flat or curved displays or screens or it can include a single curved display or screen. The screens can be rotated relative to one another. The screens 105a-c can also have respective inclinations relative to one another. The screens 105a-c of the immersive display system 100 can include flat screens, curved screens, or a combination of both.

The example immersive display system 100 includes three planar front-projection screens wherein the image on each screen is provided by a projector system. Projector system 200a is configured to project video onto screen 105a, projector system 200b is configured to project video onto screen 105b, and projector system 200c is configured to project video onto screen 105c. Sound systems may be mounted behind screen 105a, screen 105b and/or screen 105c.

Light emerging from the projector systems 200a-c can each have different spectra. This may result in color differences between the images provided by these projector systems. These color differences can be electronically compensated. An example method for compensating color differences between two projectors is disclosed in U.S. Pat. Pub. No. 2007/0127121 to B. Maximus et al., which is incorporated by reference herein in its entirety. The spectra of the projector systems 200a-c can be configured to project, after electronic compensation, color images with a color gamut according to Rec. 709 or DCI P3, for example.

The projector systems 200a-c refer to devices configured to project video on the screens 150a-c. These projector systems 200a-c can include a media server and a projector. In some embodiments, the media server is physically separate from the projector and is communicably coupled (e.g., through wired or wireless connections) to the projector. In some embodiments, the projector system comprises an integrated media server and projector. The media server portion of the projector system can include hardware and software components configured to receive, store, and decode media content. The media server can include hardware and software configured to ingest and decode digital content files, to produce a media stream (e.g., video and audio), to send image data to the projector. The media server can include modules for ingesting digital content, decoding ingested content, generating video from the decoded content, generating audio from the decoded content, providing security credentials to access secure content, and to generate or interpret synchronization signals to provide a synchronized presentation, and the like. The projector can include an optical engine, a modulation element, optics, and the like to enable the projector to produce, modulate, and project an image. For example, the projector may be implemented using a cathode ray tube (CRT), a liquid crystal display (LCD), digital light processing (DLP), digital micro-mirror devices (DMD), etc.

The projector systems 200a-c can be configured to provide video with an aspect ratio and resolution conforming to any of a number of standards including, for example and without limitation, 4K (e.g., 3636x2664, 3996x2160, 3840x2160, 4096x2160, etc.), 2K (e.g., 1828x1332, 1998x1080), HD (e.g., 1920x1080, 1280x720), or the like. The projector systems 200a-c can be configured to provide video with a variety of frame rates including, for example and without limitation, 24 fps, 30 fps, 60 fps, 120 fps, etc. The projector systems 200a-c can be configured to display synchronized 3D content (e.g., stereoscopic video) on two or more screens.

As illustrated in FIG. 1, the projector system 200a can be configured to be the master projector system. As used herein, the master projector system or the master media server provides the synchronization signal to which the slave projector systems synchronize their output. The master projector system 200a ingests, decodes, and/or provides the main audiovisual presentation in the immersive display system 100. Projector systems 200b and 200c are slave projector systems. As used herein, a slave projector system or slave media server provides images synchronized to the master system wherein synchronization is based at least in part on the synchronization signal provided by the master projector system. A slave projector system may provide video that is projected peripheral, adjacent, near, and/or otherwise complementary to the video provided by the master system.

The master projector system 200a transmits a synchronization signal over the cabled connection 130a to a first slave projector system (e.g., projector system 200b) that then transmits the same synchronization signal over the cabled connection 130b to a second slave projector system (e.g., projector system 200c). The synchronization signal is the same or substantially the same for all projector systems to enable globally synchronized video in the immersive display system. Accordingly, due at least in part to the projector systems 200a-c projecting video based on the synchronization signal, a synchronized video presentation is provided on the screens 150a-c. As used herein, synchronized video includes video from different projector systems having corresponding frames that are displayed within a sufficiently small time window from one another so as to be displayed substantially simultaneously. In some embodiments, synchronized video includes video wherein corresponding frames are displayed such that a time between the display of the synchronized frames is less than or equal to about 1 ms, less than or equal to about 500 μs, less than or equal to about 350 μs, less than or equal to about 250 μs, or less than or equal to about 200 μs. Such synchronization can be referred to as having sub-frame accuracy in its synchronization. For example, for a video that has a frame rate of 30 fps (or 60 fps), each frame of video is displayed for about 33.3 ms (or 16.7 ms). Videos that are synchronized to within a fraction of the time a video frame is displayed can be said to have sub-frame accuracy. For example, sub-frame accuracy can include synchronization that has a latency between corresponding frames that is less than about 10% of the frame rate, less than about 5% of the frame rate, less than about 1% of the frame rate, or less than about 0.1% of the frame rate.

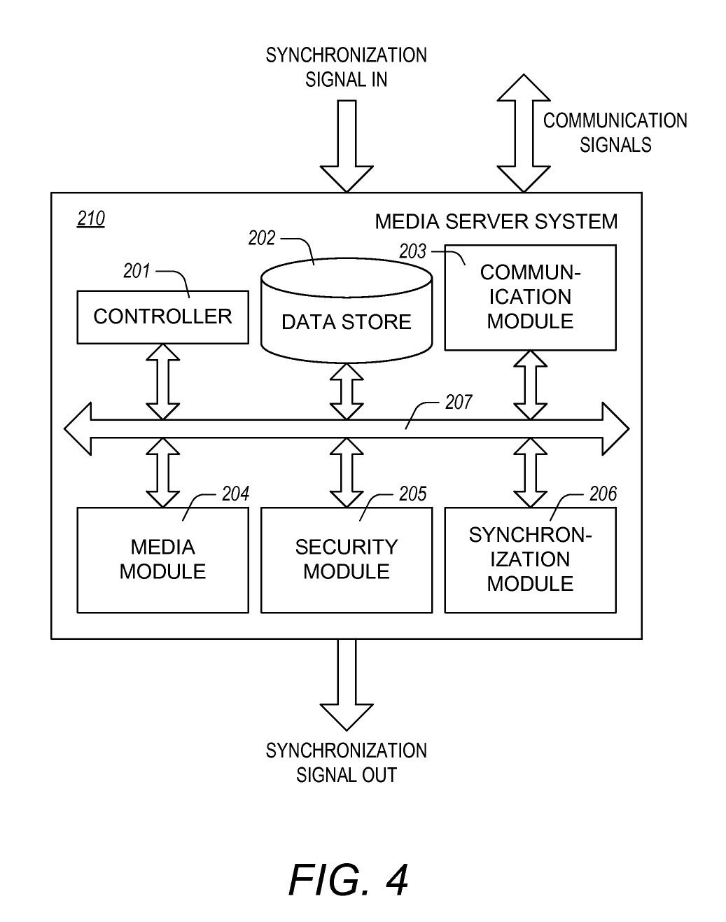

In some embodiments, the master projector system 200a can control display of a video in units of frames and synchronize the video frames from projector systems 200b and 200c using a time code for each frame, the time code being carried by the synchronization signal, as described in greater detail herein with reference to FIG. 4. Accordingly, the projector systems 200a-c can accurately synchronize the video projected on screens 150a-c based at least in part on the time code for each frame in the synchronization signal.

As an example, the immersive display system 100 can include DCI-compliant projector systems 200a-c configured to play DCI-compliant content inside a movie theater. The DCI-compliant content can include a media stream (e.g., video data or video and audio data extracted from digital content). In some implementations, the media stream is provided as a digital cinema package (“DCP”) comprising compressed, encrypted, and packaged data for distribution to movie theaters, for example. The data can include a digital cinema distribution master (“DCDM”) comprising the image structure, audio structure, subtitle structure, and the like mapped to data file formats. The data can include picture essence files and audio essence files that make up the audiovisual presentation in the DCP. The DCP can include a composition which includes all of the essence and metadata required for a single digital presentation of a feature, trailer, advertisement, logo, or the like. The projector systems 200a-c can be configured to ingest the DCP and generate a visually indistinguishable copy of the DCDM and then use that copy of the DCDM to generate image and sound for presentation to an audience.

FIG. 1 illustrates 3 projector systems 200a-c and 3 screens. However, the immersive display system can include a different number of projector systems and/or screens. For example, the immersive display system 100 can include 2, 3, 4, 5, 6, 7, 8, 9, 10, or more than 10 projector systems. The immersive display system 100 can include 2, 3, 4, 5, 6, 7, 8, 9, 10, or more than 10 screens. The immersive display system 100 can be configured such that more than one projector system provides video on a single screen, such that the images substantially overlap. The immersive display system 100 can be configured such that projector systems provide video on a single screen wherein the videos from projector systems minimally overlap, are adjacent to one another, or are near one another to provide a substantially unitary video presentation.

### Example Projector Systems

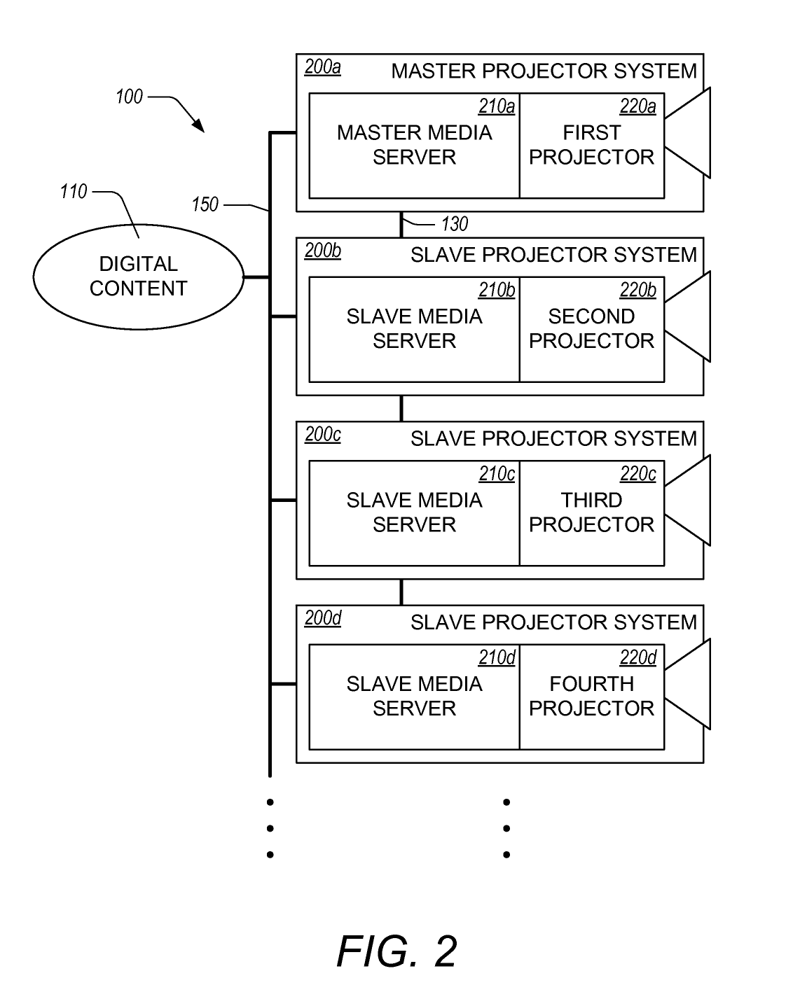

FIG. 2 illustrates a plurality of example projector systems 200a-d ingesting digital content 110 for display in an immersive display system 100. The digital content 110 can be any collection of digital files that include content data and metadata that make up a composition to be displayed by the immersive display system 100. The digital content 110 can be ingested by the plurality of projector systems 200a-d through network connection 150. The media servers 210a-d can be configured to extract the appropriate data files from the ingested digital content 110 and to decode the appropriate video content to send to the corresponding projector 220a-220d. The master projector system 200a can generate a synchronization signal to send over a cable 130 (e.g., a coaxial cable) to a first slave projector system 200b. The first slave projector system 200b can then send the synchronization signal to a second slave projector system 200c that can then send it to a third slave projection system 200d and so on. In this way, the immersive display system 100 can display synchronized video from a plurality of projector systems.

In some embodiments, the master and slave projector systems 200a-d can be configured to ingest only portions of the digital content 110 intended for that particular projector system. For example, a projector system 200a-d can download portions of a digital package that contain the data sufficient to provide the content intended for that particular projector system. In some embodiments, the master projector system 200a ingests the entire digital content 110 and distributes a copy of that digital content 110 to the slave projector systems 200b-d. In some implementations, after ingesting the digital content 110, the master distributes a portion of the digital content 110 to each slave projector system 200b-d wherein the portion transmitted to a slave projector system contains the data sufficient for that particular slave projector system to provide its audiovisual presentation. Transmission of digital content 110 can occur over the network connection 150 which can be a wired connection, a wireless connection, or a combination of both wired and wireless connections.

The master projector system 200a can transmit copies of the digital content 110 or copies of portions of the digital content 110 to the slave projector systems 200b-d over the network connection 150. In such circumstances, the master projector system 200a can transmit the digital content 110 to the slave projector systems 200b-d prior to presentation of the composition contained in the digital content 110, during presentation of the composition by buffering the data in each slave projector system 200b-d, and/or during presentation of the composition in real time. In some implementations, the master projector system 200a can transmit information to the slave projector systems 200b-d indicating which portion of the digital content 110 that each slave projector system should ingest. Based at least in part on this information, each slave projector system 200b, 200c, 200d can ingest a portion of the digital content 110.

The digital content 110 and the projector systems 200a-d can be configured to conform to digital cinema standards, such as the Digital Cinema System Specification (“DCSS”) that describes, among other things, data file formats, hardware capabilities, security standards, and the like. Such specifications, like the DOSS, can allow a variety of different content producers, different distributors, and different presenters to work together to generate, distribute, and display digital content to an audience, such as movies. Movie theaters and other such venues that present digital content, such as movies, can then invest in systems that can display digital content packaged according to the specification.

The digital content 110 can include data that conforms to a single specification. For example, the digital content 110 can be a digital cinema package (“DCP”). In some embodiments, the standard associated with the DCP can be expanded to include multi-view content (e.g., video to be simultaneously displayed on a plurality of screens). The DCP can include the data (e.g., audio, video, and metadata) for each screen in the immersive display system 100. In certain implementations, the DCP can be configured to have a composition playlist (“CPL”) for each screen in the immersive display system 100. In some embodiments, the digital content 110 includes a DCP for each screen in the immersive display system 100. Based at least in part on the DCP and/or CPL contained in the digital content 110, each projector system 200a-d can implement a smart ingest function that limits ingestion of the digital content 110 to the relevant portions of the digital content 110 for its intended screen. In certain implementations, the immersive display system 100 displays DCP content from the projector systems 200a-d blended together to accommodate a curved screen.

The digital content 110 can include data that conforms to a plurality of specifications. For example, a portion of the digital content 110 can be a DCP while other portions can include data conforming to another specification. Similarly, the digital content 110 can include data that conforms to a specification and data that does not conform to a specification. For example, a portion of the digital content 110 can be a DCP while other portions can include non-DCP data.

The systems and methods described herein can advantageously allow the synchronization of video from a plurality of projector systems when the digital content 110 conforms to a single specification, multiple specifications, or a combination of a single specification and no specification. This advantage is realized due at least in part to the master projector system 200a generating the synchronization signal after decoding the video content. The master projector system 200a can generate an appropriate timeline and metadata independent of the format of the digital content 110 and encode that information into the synchronization signal. In some embodiments, the synchronization can be done between the video frames (e.g., line-based synchronization). For example, the master projector system 200a can generate the synchronization signal after the frame buffer output in the projector, prior to the modulation portion of the projector (e.g., a DMD chip). Each slave projector 200b-d can receive the synchronization signal and control its display of video based on the timeline and metadata in the signal. For example, the slave projector systems 200b-d can frame-lock to the synchronization signal at a similar hardware level to the master projector system 200a (e.g., after the frame buffer and prior to the modulation chip). Thus, in some embodiments, the projector systems 200a-d can be synchronized on a frame-basis, frame-locking content wherein timing is linked on a frame-by-frame basis. Accordingly, the immersive display system 100 can synchronize the projector systems 200a-d with each other for content playback with sub-frame accuracy, wherein each server has a different DCP, a different CPL in a single DCP, and/or a DCP and non-DCP content.

The immersive display system 100 can also synchronize video having different aspect ratios, different content formats (e.g., JPEG2000, MPEG4, etc.), and/or different frame rates. For example, side screens can have a frame rate that is higher than a frame rate of the main screen or vice versa. In some embodiments, synchronization of different frame rates can occur where the differing frame rates are multiples of one another (e.g., 30 fps and 60 fps), multiples of a common frame rate (e.g., 24 fps and 60 fps are both multiples of 12), or where the data rate of the synchronization signal allows for synchronization at differing frame rates (e.g., where the base frequency of the synchronization signal is a multiple of possible frame rates). The immersive display system 100 can also synchronize video that is stereoscopic, not stereoscopic, or a combination of both.

In some embodiments, the immersive display system 100 can display non-DCP content (e.g., provided by slave projector systems 200b, 200c, and/or 200d) synchronized to DCP content (e.g., provided by the master projector system 200a). This can allow for dynamic content (e.g., feeds from social media, advertisements, news feeds, etc.) to be displayed along with a main video presentation (e.g., a feature film). In some embodiments, one or more of the slave projector systems 200b-d provides the dynamic, synchronized content overlaid on the main screen or on a side screen.

In some embodiments, the master projector system 200a provides content from a DCP on a main screen and at least 2 slave projector systems 200b, 200c provide content from a non-DC source on side screens. In some embodiments, the master projector system 200a and the slave projector systems 200b-d provide subtitles synchronized across multiple screens. For example, different subtitles can be displayed on different screens. In certain implementations, the subtitles are a part of the content package. In some implementations, subtitles can be acquired from a different source and can be displayed on one or more screens in synchrony with the video. In some embodiments, one or more of the slave projector systems 200b-d are configured to display news feeds (e.g., rich site summary or RSS feeds) on side screens synchronized with the video provided by the master projector system 200a on a main screen. For example, the master projector system 200a can display a composition on the main screen (e.g., a feature film in JPEG2000) and at least one slave projector system 200b-d can overlay a live rendering of an RSS feed (e.g., a feed from a social networking website like Twitter®) over the composition. In some embodiments, the projector systems 200a-d can leverage existing hardware and software configured to display subtitles to display additional or alternative textual content.

In some embodiments, one or more of the media servers 210a-210d can be physically separate its associated projector 220a-d. In such cases, the synchronization signal can be generated by the main media server 210a prior to the frame buffer output, as described herein. Similarly, the slave media servers 210b-d can synchronize video output prior to its frame buffer output.

The master projector system 200a and the slave projector systems 200b-d can be substantially identical devices. In some implementations, the user can configure the devices to assume the roles of master and slave. In certain implementations, the content ingested by the devices determines, at least in part, the role of the projector system (e.g., master or slave). The immersive display system 100 can thus be configured to not include any specific main server that controls the slave projector systems.

The master projector system 200a can include hardware and/or software components that differentiate it from the slave projector systems 200b-d. For example, the master projector system 200a can include hardware and/or software specific to generating the synchronization signal. Similarly, the slave projector systems 200b-d can include hardware and/or software specific to synchronizing video output based on the synchronization signal.

The immersive display system 100 can operate in an automation system (e.g., a theater management system or “TMS,” and/or a screen management system or “SMS”). In a TMS, for example, the immersive display system 100 can be treated as a single entity. This can allow existing TMS's to expand operation relatively easily from exclusively operating single-screen projection systems to incorporating the immersive display system 100.

### Example Sequentially Chained Projector Systems

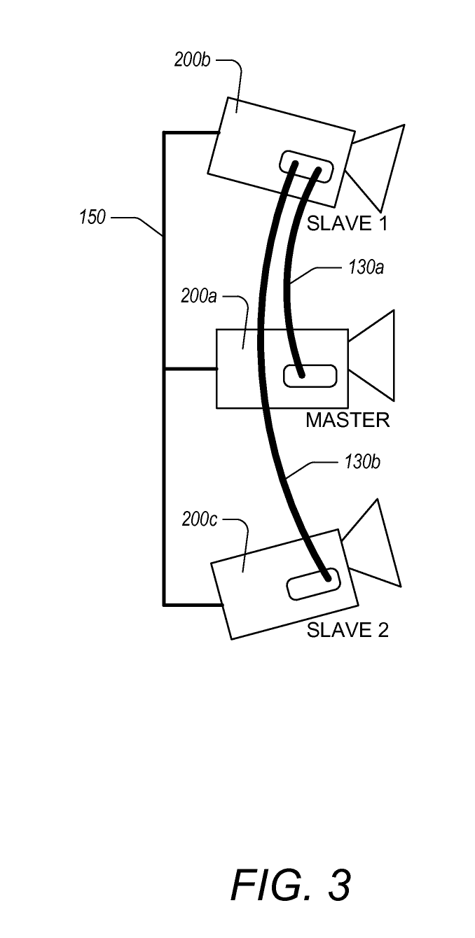

FIG. 3 illustrates a plurality of example projector systems 200a-c displaying synchronized video on a plurality of screens. The projector systems 200a-c are connected in serial with cables 130a and 130b to relay a synchronization signal from the master projector system 200a to a first slave projector system 200b and then to a second slave projector system 200c. Communication over the cables 130a, 130b occurs in real Lime and at a data rate sufficient to synchronize video between the projector systems 200a-c with sub-frame accuracy.

As an illustrative and non-limiting example, each projector system 200a-c can have a single DCP stored thereon. The master projector system 200a can extract video from its DCP and generate a synchronization signal based at least in part on the video. The master projector system 200a can display the video on a main screen. The master projector system 200a can transmit the synchronization signal to the first slave projector system 200b over a first coaxial cable. The first slave projector system 200b can extract video from its DCP and use the synchronization signal to synchronize the presentation of the video on a first side screen with that of the master projector system 200a. The first slave projector system 200b can also re-transmit the synchronization signal, in parallel with processing the synchronization signal, to the second slave projector system 200c over a second coaxial cable. The second slave projector system 200c can extract video from its DCP and use the synchronization signal to synchronize the presentation of the video on a second side screen with that of the master projector system 200a.

The projector systems 200a-c can also be communicably coupled via a network connection 150 that can be wired (e.g., using an Ethernet connection), wireless (e.g., using a wireless networking protocol such as IEEE 802.11n), or a combination of both. In some implementations, communication over the network connection 150 does not need to support real-time communication. In certain implementations, video can be sent from the master projector system 200a to one or more of the slave projector systems 200b, 200c over the network connection 150. The video can be sent prior to presenting the video or while the video is being presented (e.g., using a buffering system or in real time). In certain implementations, each projector system 200a-c uses the network connection 150 to ingest content to be displayed. It is to be understood that the slave projector systems 200b, 200c can be synchronized with the master projector system 200a without the network connection 150 being present or being connected to less than all of the projector systems 200a-c. For example, one or more projector system 200a-c can ingest content for presentation from a computer readable storage medium (e.g., a Blu-Ray disc, a USB drive, etc.) and that content can be synchronized with the content provided by the serially connected projector systems 200a-c with cables 130a, 130b.

The master projector system 200a produces a synchronization signal based at least in part on the content it is providing (e.g., video and/or audio) to provide over the cable 130a to a first slave projector system 200b. The synchronization signal can be time-coded so that the first slave projector system 200b can synchronize its video output with the output of the main projector system 200a. Additional slave projector systems can be added to the chain of projector systems by adding another link in the chain. For example, the second slave projector system 200c can be added by connecting it to the first slave projector system 200b with the cable 130b. The first slave projector system 200b can then propagate the synchronization signal it received from the master projector system 200a to the second slave projector system 200c. Adding more slave projector systems follows this same pattern. A slave projector system is added and a cable is connected between it and the previous slave projector system so that the previous slave projector system can propagate the synchronization signal to the newly added slave projector system.

The total number of projector systems 200 can be varied based at least in part on the intended use. The maximum number of projector systems 200 can be based at least in part on acceptable accuracy in synchronization. Each additional projector system increases the overall latency in the system, potentially reducing synchronization accuracy. As used herein, the latency in the system can be related to the time between when the master projector system 200a sends the synchronization signal and when the last slave projector system in the chain receives the synchronization signal. The latency in the system can also be related to the time difference between when a video frame is displayed in the master projector system 200a and when a corresponding video frame is displayed in a slave projector system 200b, 200c. The latency in the system can also be related to a time difference between when a video frame theoretically should be displayed and when the video frame is actually displayed.

In some embodiments, the acceptable accuracy in synchronization can be measured as a fraction of the time between successive video frames in the master video (e.g., the frame display time for the video provided by the master projector system 200a) where the acceptable accuracy can be less than or equal to about 10% of the frame display time, less than or equal to about 5% of the frame display time, less than or equal to about 1% of the frame display time, less than or equal to about 0.1% of the frame display time, or less than or equal to about 0.01% of the frame display time. In some embodiments, the acceptable accuracy in synchronization can be measured in seconds where the acceptable accuracy can be less than or equal to about 1 ms, less than or equal to about 500 μs, less than or equal to about 350 μs, less than or equal to about 250 μs, less than or equal to about 200 μs, less than or equal to about 100 μs, or less than or equal to about 50 μs. In some implementations, the total number of systems is, for example and without limitation, 3 systems, 4 systems, 5 systems, 6 systems 7 systems, 8 systems, 9 systems, 10 systems, 15 systems, 20 systems, at least 10 systems, or between 3 and 10 systems.

The synchronization signal can be configured to be a waveform that can encode data into it (e.g., using digital methods). For example, the synchronization signal can include words defined to be 64 bits of information each. Each word can include synchronization information (e.g., a time code) and/or additional information such as commands for slave projector systems. In some embodiments, the data rate of the synchronization signal can be about 2 Mbps. If each word in the signal is 64 bits, the latency due to constraints imposed by the synchronization signal is about 32 μs (2 Mbps/64 bits per word is about 31,250 words/s). Other data rates and/or word sizes are possible that would result in different calculated and measured latencies.

The synchronization signal can also include commands intended for one or more slave projector systems 200b, 200c. Commands can also be sent to slave projector systems 200b, 200c over the network connection 150. Commands encoded into the synchronization signal can be commands intended for real time or near real time execution. For example, commands sent over the synchronization signal can include commands to change a side screen color space, brightness, or the like based at least in part on metadata in the content (e.g., if an image on a side screen is bright a command in the synchronization signal can weight side screen projector outputs less light to reduce effects on the content projected on the main screen). Commands sent over the network connection 150 can be commands intended for near real time execution or delayed execution. For example, commands to open or close a dowser or to load content can be sent over the network connection 150.

In some embodiments, there can be an independent set delay of content between screens by indicating a delay with the synchronization signal. For example, the synchronization signal can include a timeline adjustment that provides the ability to adjust individual videos displayed by each projector system. In some embodiments, if one or more of the slave projector systems 200b, 200c stop displaying video content (e.g., due to a malfunction), the master projector system 200a can be configured to continue displaying video.

Daisy-chaining the projector systems 200a-c together in serial provides a number of advantages relative to synchronizing projector systems through a parallel connection. For example, daisy-chaining the projector systems 200a-c allows an immersive display system to avoid the use of an external synchronization or signal amplification device. As another example, the projector systems 200a-c can be connected together using simple cabling, such as coaxial or BNC cables, from one projector to the next. Such a serial connection can result in a relatively small latency. The synchronization signal can be implemented by modifying or employing existing synchronization technology such as linear time coding (“LTC”) or AES3 signals (e.g., a signal conforming to the IEC 60958 standard) that can be used over coaxial cables or other similar cables thus reducing potential obstacles to implementing the technology in existing projector or other display systems.

### Example Media Server

FIG. 4 illustrates a block diagram of an example media server system 210. The media server system 210 can be a master media server or a slaver media server. The media server system 210 can be configured to generate a synchronization signal (e.g., when it is a master media server system), transmit the synchronization signal (e.g., over a synchronization link such as a coaxial cable), receive a synchronization signal (e.g., when it is a slave media server system), synchronize presentation of a video based at least in part on the synchronization signal, send and receive communications over a network connection, process digital files to generate a video, provide security credentials to extract video, and the like. The media server system 210 can include hardware and software sufficient to accomplish the functionality described herein.

The media server system 210 includes a controller 201, such as a computer processor, and a data store 202, such as non-transitory computer storage. The controller 201 can be configured to provide computational power and to direct and coordinate the execution of functions sufficient to provide the targeted and desired functionality of the media server system 210. The data store 202 can be used to store digital files, e.g., a DCP, software, executable instructions, configuration settings, calibration information, and the like. In some embodiments, the media server 210 provides a user interface or a control program accessible over a network connection that allows a user or other system to provide commands to the media server system 210, to monitor a status of the media server system, and/or to request information from the media server system 210. In some embodiments, a user or other system can communicate with the master media server in an immersive display system to control all of the media servers in the immersive display system.

The media server system 210 includes a communication module 203 configured to process, send, receive, construct, and/or interpret information over a network connection, such as the network connection 150 described herein with reference to FIGS. 2 and 3. For example, the communication module 203 can be configured to ingest digital content for display by an associated projector. As described herein, the communication module 203 can be configured to perform a smart ingest function wherein data necessary for displaying content on the associated projector is ingested and other data is not ingested. The communication module 203 can be configured to send commands to be performed by connected media servers. For example, a master media server can command one or more slave media servers to control its associated projector system by dowsing the shutter or other similar functionality. The communication module 203 in a slave projector system can be configured to receive and interpret commands received from a master projector system.

The media server system 210 includes a media module 204 configured to process digital data to generate a video presentation. The media module 204 can be configured to extract packaged files from a standard format, such as a DCP package, and to provide an appropriate signal to a projector so that the projector displays intended video. For example, to display a feature film, the media module 204 can decompress digital files, identify an appropriate playlist file, decode associated image essence files, decode associated audio essence files, and produce a video signal that is sent to a projector for display.

The media server system 210 includes a security module 205 configured to provide appropriate security functionality to access secure digital files. For example, a DCP can be encrypted to prevent unauthorized access. The security module 205 can provide appropriate security credentials and decrypt the digital files so that the media module 204 can access the files. The security module can also provide security functionality when the video signal generated by the media module 204 is to be sent over a cable to the projector, such as when the projector is physically separate from the media server system 210.

The media server system 210 includes a synchronization module 206 configured to generate a synchronization signal (e.g., when the media server 210 is part of a master projector system), transmit the synchronization signal (e.g., over a synchronization cable), and/or process the synchronization signal (e.g., when the media server 210 is part of a slave projector system). The synchronization module 206 can be configured to generate the synchronization signal. The synchronization signal can be generated independent of synchronization information provided in the digital files related to the composition (e.g., video presentation). For example, the synchronization signal can be generated based at least in part on the video signal generated by the media module. The synchronization signal can be generated based at least in part on the output of a frame buffer in the projector, prior to (or in parallel with) the video signal being input into a modulation chip in the projector.

The synchronization signal can be a waveform having information that is encoded therein. The waveform can utilize a biphase mark code (“BMC”) to encode data (e.g., as used in AES3 and S/PDIF signals). The synchronization signal encoded with BMC can be polarity insensitive which can be advantageous in an immersive display system with a plurality of projector systems. The waveform can be divided into words, or groups of bits, with information encoded at particular places within the words. The waveform can have one or more encoded words. The synchronization waveform can be a modified linear time code (“LTC”) or a modified AES3 signal. The waveform can encode SMPTE timecode data to enable synchronization of slave projector systems to the master projector system. The waveform can also encode commands or other information (e.g., metadata) addressed to or intended for one or more projector systems.

As an illustrative and non-limiting example, the synchronization signal can include two 64-bit words. The first word can include a 24-bit frame number, a valid status bit, a channel status bit, a user data bit, a parity bit (e.g., to validate a received word). In certain implementations, an active edge in the user data bit can be used to indicate that the master projector system will start the next frame. The second word can contain a command structure used by a master projector system to provide commands to connected slave projector systems. Additional data, such as metadata, can be included in the first or second word. For example, the second word can include a 24-bit instruction from the master projector system to connected slave projector systems. The metadata can be used to provide information to the slave projector systems to modify their functionality. For example, metadata can be used to indicate that the master projector system is paused. The slave projector systems can then pause their playback until another signal is received indicating that playback on the master projector system has resumed. The synchronization signal can be a modification of standard signals, such as the LTC or AES3 signal. This can allow existing projector systems, hardware, and/or software to incorporate elements sufficient to implement the synchronization signal in a relatively straight-forward and easy fashion.

The synchronization module 206 can include look-up tables, data structures, data tables, data bases, or the like to interpret the signals encoded into the synchronization signal. For example, the synchronization module 206 can include a command table that correlates commands with numbers encoded into the synchronization signal.

As an illustrative and non-limiting example, the synchronization signal can have a data rate of about 2 Mbps. When the synchronization signal is encoded using 64-bit words, the data rate is about 32 μs/word. Where the synchronization signal includes two words, the time to transmit a packet (e.g., the two words) is about 64 μs.

The synchronization module 206 can be configured to adjust display of a video frame based at least in part on the synchronization signal. For example, the synchronization module 206 can wait for a matching frame id received in the synchronization signal. When the matching frame id is received, the synchronization module 206 can indicate to the projector to display the appropriate video frame.

In some embodiments, the synchronization module 206 generates the synchronization signal based at least in part on audio provided by the media module 204. For example, sound can be generated by the master projector system and the timing of the audio can drive the video synchronization chain. The audio can be processed by the media module 204 in real time and the video frames can be specified in terms of the number of clock cycles relative to the audio clock domain. This can enable automatic alignment of audio and video during playback. In some embodiments, continuous or substantially continuous adjustments to video playback can be performed during the video blanking time slot (e.g., using a back-pressure algorithm). Accordingly, the master projector system can play audio in real time and display the video synchronized to the audio using the media module 204. The master projector system also provides a synchronization signal via the synchronization module 206 to connected slave projector systems. The slave projector systems can then synchronize their video to this synchronization signal provided by the master projector system, making it so that their video is synchronized with the master video and not necessarily to their audio.

### Slave Media Server Synchronization

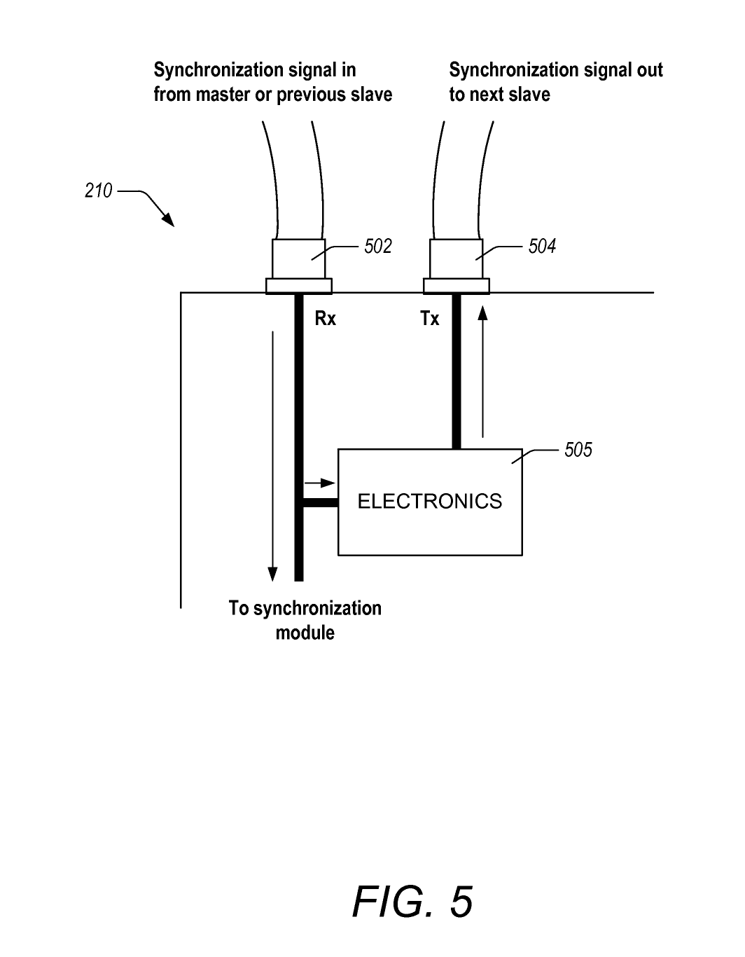

FIG. 5 illustrates a slave media server 210 receiving a synchronization signal at a first connector 502 and transmitting the synchronization signal from the connector 504 to the next slave media server in the chain. The first and second connectors 502, 504 can be standard connectors used for sync-in and sync-out signals generally used in this field, such as BNC connectors.

Upon receiving the synchronization signal at connector 502, the slave media server 210 can loop the signal from the Rx port to the Tx port using active electronics 505. In some embodiments, the active electronics includes an amplifier. In some embodiments, the active electronics 505 are configured to reduce the introduction of latency into the synchronization chain.

The slave media server 210 can also direct the synchronization signal to the synchronization module for processing and utilization. The slave media server 210 can include hardware and software components configured to extract synchronization information from the synchronization signal and to control video playback based at least in part on the extracted synchronization information. For example; the slave media server 210 call include hardware configured to frame-lock its playback to the synchronization signal.

### Modular Media Server Module

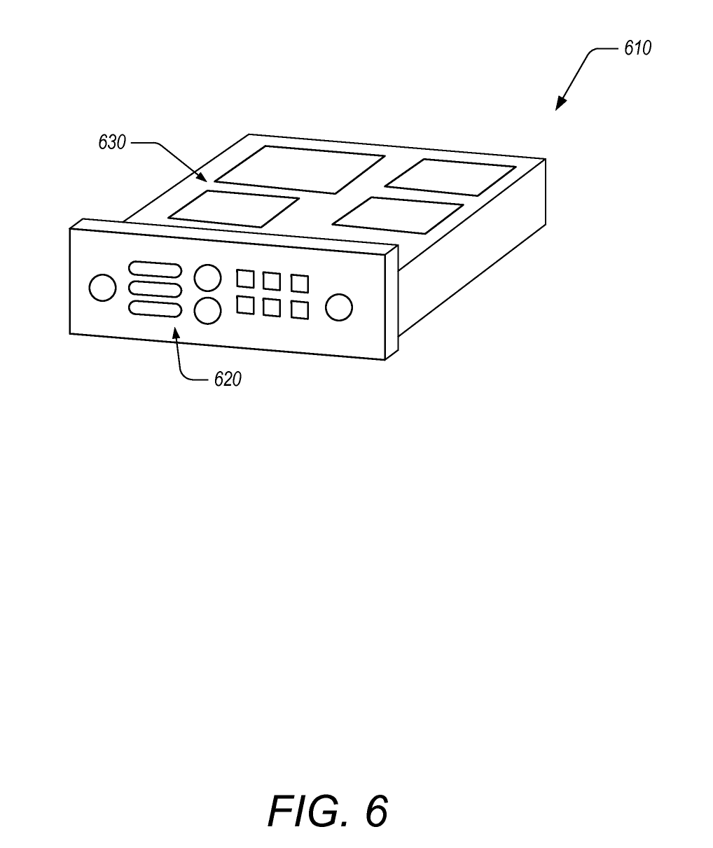

FIG. 6 illustrates an example media server module 610 configured to allow a projector system to be upgraded from a single-screen projector system to a projector system that can part of an immersive display system, such as the immersive display system described herein with reference to FIGS. 1 and 2. The media server module 610 can include connectors and interface elements 620 to provide compatibility with existing projector system infrastructure, such as those present in a screen management system (“SMS”). The media server module 610 can also include electronics 630 configured to provide the functionality described herein with reference to FIG. 4. For example, the connectors 620 and the electronics 630 can be configured to receive a synchronization signal and control video playback based at least in part on the synchronization signal. As another example, the connectors 620 and the electronics 630 can be configured to generate a custom synchronization signal to synchronize video playback among a plurality of projector systems. As another example, the connectors 620 and the electronics 630 can be configured to be part of a sequentially chained projector system wherein the synchronization signal is passed sequentially among serially connected projector systems.

The media server module 610 can be configured to be integrated into a projector system such that the media server module 610 is configured to drive a projector of the projector system. In this way, the media server module 610 allows the projector system to be updated and upgraded without requiring replacement of the projector. Thus, the media server module 610 provides a way to upgrade a projector system to include immersive presentation capabilities described herein. In addition, the media server module 610 can act as an integrated cinema media processor, providing functionality of an integrated cinema processor and a media server. This can convert a projector system into a DCI-compliant projector and media server.

### Media Stream Synchronization Method

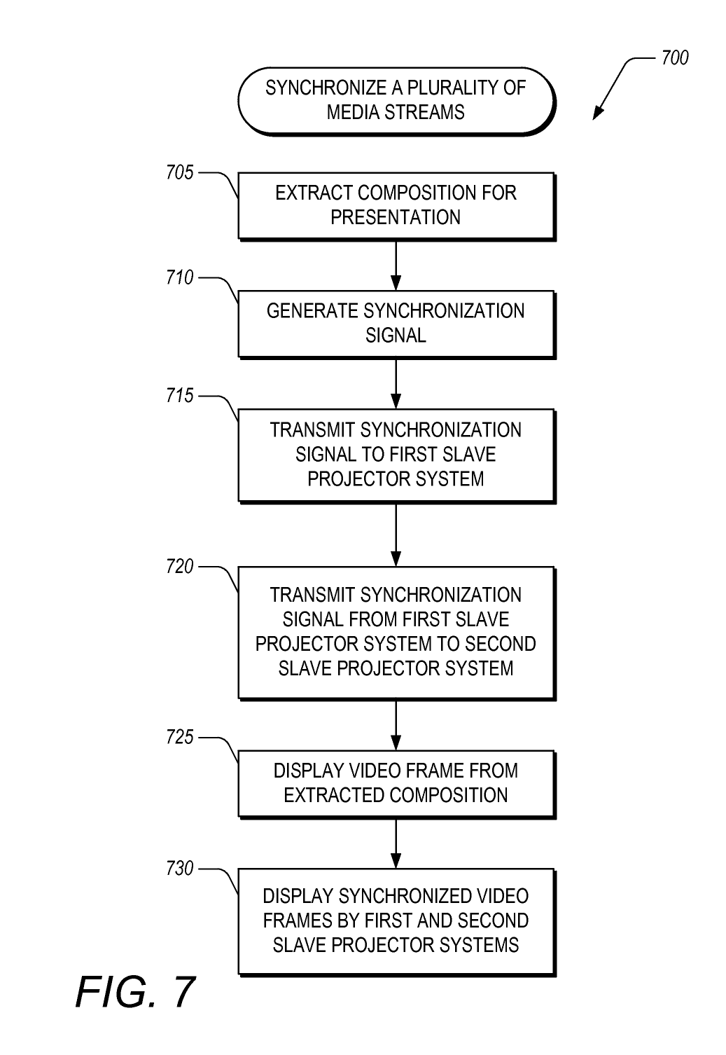

FIG. 7 illustrates a flow chart of an example method 700 of synchronizing multiple media streams in serially connected media servers in an immersive display system. The method 700 can be performed by a plurality of projector systems and/or media servers in an immersive display system. One or more media servers, such as the media servers described herein with reference to FIG. 2, 4, 5, or 6, can perform one or more of the steps of the method 700. In addition, one or more modules of the media server, such as those described herein with reference to FIG. 4, can perform one or more of the steps of the method 700. Furthermore, a single step of the method 700 may be performed by more than one module and/or projector system.

In block 705, a master projector system extracts a composition for presentation. As described herein, the composition can include video and/or audio to be presented to an audience. The composition can include video to be displayed by the master projector system. In some implementations, the composition can include video to be displayed by two or more slave projector systems. In such scenarios, the master projector system can transmit the data sufficient to display the video to the respective slave projector systems. In some embodiments, two or more slave projector systems each extract a composition for presentation by the respective slave projector system.

In block 710, the master projector system generates a synchronization signal based at least in part on the extracted composition. The synchronization signal can encode data words into a synchronization waveform. The encoded data words can include synchronization information in the form of a timecode. In some embodiments, the master projector system generates the synchronization signal based at least in part on audio in the composition for presentation by the master projector system.

In block 715, the master projector system transmits the synchronization signal to a first slave projector system. The master projector system can transmit the synchronization signal over a coaxial cable or other cable with a signal line and a ground. In block 720, the first slave projector system receives the synchronization signal and retransmits the synchronization signal to a second slave projector system. The first slave projector system can receive the synchronization signal at an input synchronization connector and transmit the synchronization signal at an output synchronization connector.

In block 725, the master projector system displays a video frame from the extracted composition. In block 730, the first slave projector system and the second slave projector system display video frames synchronized with the video frame displayed by the master projector system wherein the displayed video frames are synchronized based at least in part on the synchronization signal generated by the master projector system. Each of the first and second slave projector systems can process the received synchronization signal to extract synchronization information. In addition, each of the first and second slave projector systems can control playback of its video (e.g., control timing of when to display a video frame) based at least in part on the extracted synchronization information.

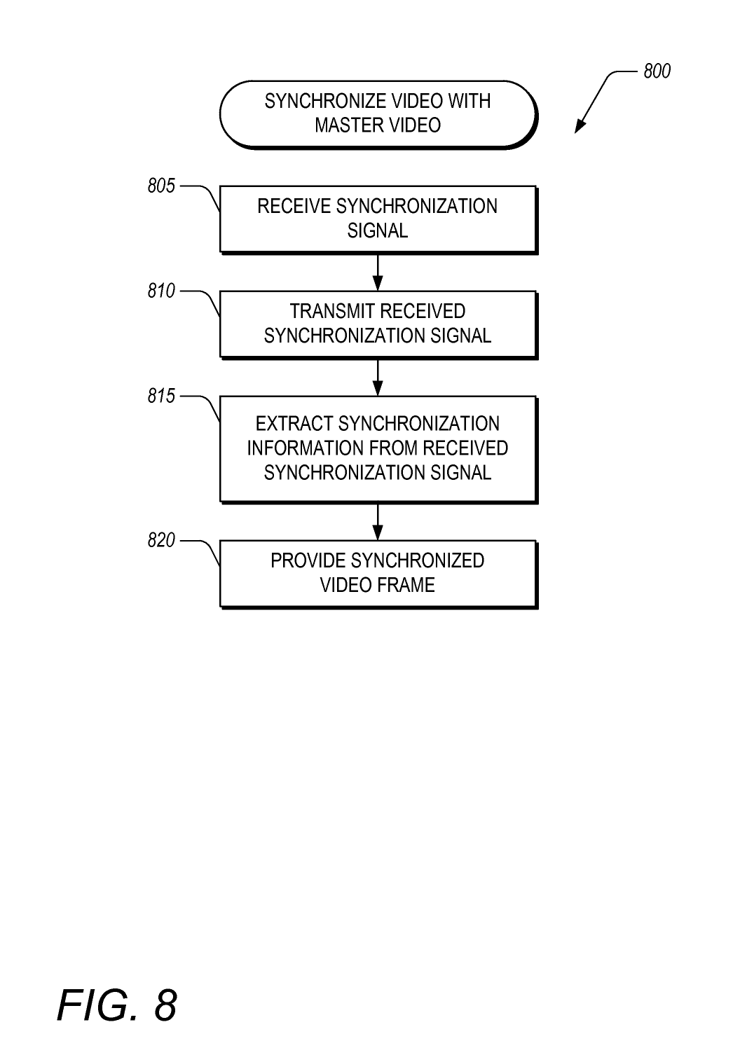

FIG. 8 illustrates a flow chart of an example method 800 of synchronizing a slave video with a master video based at least in part on a synchronization signal from a master projector system. The method can be performed by a slave projector system in an immersive display system, such as the slave projector systems described herein with reference to FIGS. 1-5. The slave projector system can include hardware and software configured to perform the steps in the method 800, and each step in the method can be performed by one or more components and/or one or more modules of the slave projector system. Similarly, one or more steps in the method 800 can be performed by any combination of hardware and software of the slave projector system. The method 800 can allow a slave projector system to synchronize a slave video with a master video. In some embodiments, the slave projector system can comprise a modified single projector system. For example, a projector system can be retrofit with a module, such as the module 610 described herein with reference to FIG. 6, that is configured to receive a synchronization signal and to synchronize its video based at least in part on the received synchronization signal. In some implementations, the synchronization signal can be generated by a master projector system that has not been specifically designed to be part of an immersive display system. For example, a projector system configured for use in a single-screen theater can generate a synchronization signal based on standards such as LTC or AES3. The slave projector system can receive the synchronization signal and synchronize its video based on that generated synchronization signal. In this way, an immersive display system can be created using existing hardware and retrofitting one or more projector systems (e.g., with the module 610) to act as slave projector systems.

In block 805, the slave projector system receives a synchronization signal. The synchronization signal can be generated by a master projector system or another system configured to generate the synchronization signal. The synchronization signal can be based on standard synchronization signals (e.g., LTC, AES3, etc.) or it can conform to a format that the slave projector system can process and from which it can extract synchronization information. The synchronization signal can be received over a cable that has a signal line and a ground line, such as a coaxial cable. It is to be understood that other cabling options are within the scope of this disclosure including, for example and without limitation, serial cables, twisted pair cables, USB cables, and the like.

In block 810, the slave projector system transmits the received synchronization signal to another slave projector system over another cable (e.g., a cable different from the cable used to receive the synchronization signal). The slave projector system can include active electronics configured to receive the synchronization signal and pass that signal to the next slave projector system in the chain. In some embodiments, the slave projector system includes amplifiers, filters, and/or other electronics configured to reduce degradation of the synchronization signal as it is passed from one slave projector system to the next.

In block 815, the slave projector system extracts synchronization information from the received synchronization signal. This can occur in parallel with the transmission of the synchronization signal in block 810. This can be done to reduce or minimize latency in the immersive display system. The synchronization information can include information sufficient for the slave projector system to provide a video frame synchronized with a video provided by another projector system (e.g., a master projector system and/or other slave projector systems). The synchronization information can include, for example and without limitation, frame numbers, timestamps, timecodes, metadata, command(s) for the slave projector system, and the like, as described in greater detail herein.

In block 820, the slave projector system provides a video frame synchronized with a video provided by another projector system. The slave projector system can synchronize the video frame at the framebuffer. The slave projector system can synchronize the video frame at a point in the processing chain prior to the framebuffer, such as at the video decoding stage. The synchronized video frame can be displayed on a screen along with video from other projector systems to provide an immersive viewing experience for a viewer.

Example of Sequentially Chained Projector Systems with Connections for Cinema Content

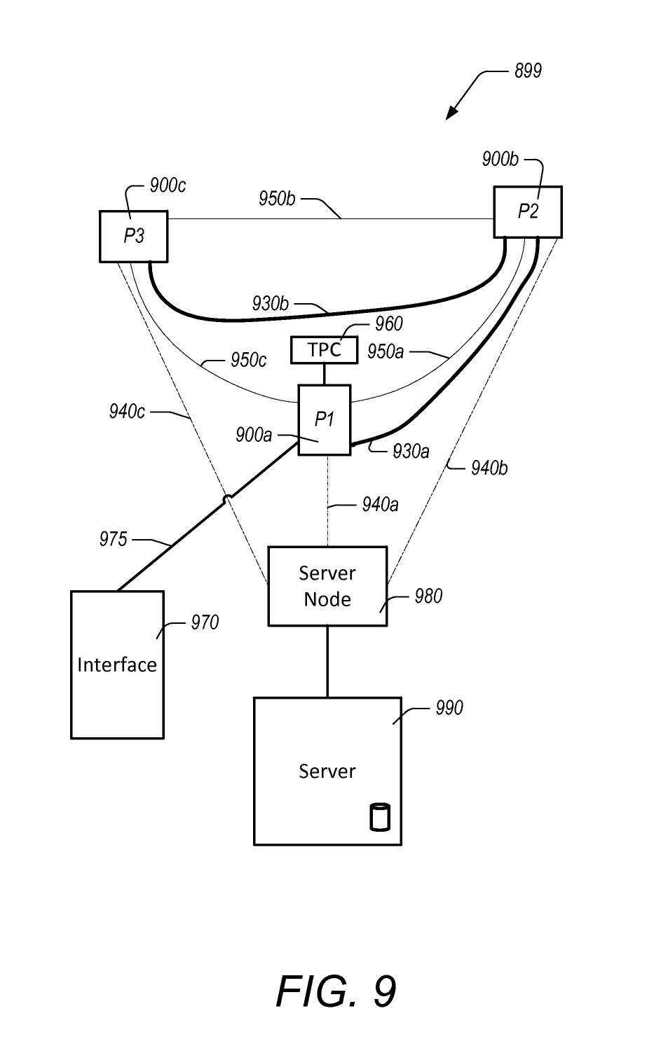

In some cases, cinema content can be first hosted on a server before being transmitted to each projector system. FIG. 9 illustrates an example immersive display system 899 for providing an immersive display experience with control connections (e.g., connections for transmitting commands) between projector systems 900a-c and connections for transmitting content to projector systems 900a-c from a server node 980. Projector systems 900a-c can be sequentially chained, as previously described in this disclosure, with cables 930a-b. Each of projector systems 900a-c can also comprise a media server. One or more media servers, such as the media servers described herein with reference to FIG. 2, 4, 5, or 6, can be used as the media servers for any of projector systems 900a-c. The media servers of projector systems 900a-c can also include an integrated cinema media processor, which can be a single or unitary electronics board that combines the functionalities of an integrated cinema processor and a media server.

Server 990 can first host the cinema content. For example, and without limitation, the cinema content can be stored as DCI-compliant content, including media streams such as DCPs and/or DCDMs. However, it is to be understood that the systems and methods provided in this disclosure can be applied to any file format used to deliver and/or package digital cinema content such as, but not limited to, REDCODE, Tagged Image File Format (“TIFF”), Tag Image File Format/Electronic Photography (“TIFF/EP”), Digital Negative files (“DNG”), Extensible Metadata Platform files (“XMP”), Exchangeable image file format (“Exif”), etc. Server 990 can include, or be coupled to, a network attached storage (“NAS”). Server 990 may also be a component of a TMS or may be part of a standalone system. The media streams can consist of a single file, a merged file, or a plurality of files.

The cinema content on server 990 can be stored in compressed, encrypted, and/or packaged form and/or uncompressed, decrypted, and/or unpackaged form. In some cases, server 990 can run software and/or have hardware that decompresses, decrypts, and/or unpackages cinema content. In some cases, the data can be uploaded onto server 990 already decompressed, decrypted, and/or unpackaged.

Cinema content from server 990 can be transmitted to server node 980 in compressed, encrypted, and/or packaged form and/or decompressed, decrypted, and/or unpackaged form. The cinema content can be transmitted over a cable that has a signal line and a ground line. For example, and without limitation, cables can include coaxial cables, Ethernet cables, HDMI cables, component cables, HD-SDI cables, etc. It is to be understood that other cabling options are within the scope of this disclosure including, for example and without limitation, serial cables, twisted pair cables, USB cables, and the like. Moreover, data can be transferred using a 1000BASE-T GB transceiver and/or any cable and/or component conforming to IEEE's Gigabit Ethernet standard. Additionally, cables can be replaced by wireless transmission (e.g., using a wireless networking protocol such as IEEE 802.11n).

From server node 980, the cinema content can be transmitted over cables 940a-c, which can comprise any of the aforementioned cables or wireless transmission, to each of projector systems 900a-c, respectively. In certain implementations, the cinema content can be configured to have a composition playlist (“CPL”) for each of projector systems 900a-c. Based at least in part on the data and/or CPL contained in the cinema content, each projector system 900a-c can implement a smart ingest function that limits ingestion of the cinema content to the relevant portions for that particular projector system. At projector systems 900a-c, the cinema content can be received by integrated cinema media processor located at each of projector systems 900a-c.

As mentioned, in some cases, the cinema content can be received by the integrated cinema media processor in decompressed, decrypted, and/or unpackaged form. As such, projector systems 900a-c may not further decompress, decrypt, un-package and/or process the cinema content for viewing. In other cases, the cinema content can be received in a compressed, encrypted, and/or packaged form. In such a case, the integrated cinema media processor of projector systems 900a-c may decompress, decrypt, and/or un-package the cinema content before it can be viewed. Projector systems 900a-c can be configured to project video (e.g., onto a screen) based on at least the received cinema content.

Optionally, cables 950a-c can also be used. Cables 950a-c can comprise any of the abovementioned cables or wireless transmissions, and further pro tide connectivity between projector systems 900a-c. In some cases, cables 950a-c can provide additional communication between projector systems 900a-c in which each can send commands and/or control signals to the other projectors. In some cases, cables 950a-c can also transmit cinema content compressed, encrypted, and/or packaged, and/or uncompressed, decrypted, and/or unpackaged between projector systems 900a-c. For example, and without limitation, transfer of cinema content can be desirable to correct content mistakenly sent to the wrong projector, to change what content is viewed on which screen, and/or to further enhance the viewing experience.

One or more of the projector systems 900a-c can be connected to one or more user interfaces to provide user inputs and/or control. The user interfaces can also display statuses, statistics/data, and log histories. The user interfaces can also contain software to manipulate/edit cinema content and/or process cinema content. For example, and without limitation, projector system 900a can be connected to interface 970 by cable 975, which can be any of the abovementioned cables or wireless transmissions. Interface 970 can be a personal computer, tablet, mobile device, web browser, and/or any device that can send and receive signals to projector system 900a. Projector system 900a can also be coupled to a computer, such as a touchscreen panel computer (“TPC”) 960, which can further allow user inputs and/or control.

### CONCLUSION

In some embodiments, a computing system that has components including a central processing unit (CPU), input/output (I/O) components, storage, and memory may be used to execute the projector system, or specific components of the projector system. The executable code modules of the projector system can be stored in the memory of the computing system and/or on other types of non-transitory computer-readable storage media. In some embodiments, the projector system may be configured differently than described above.

Each of the processes, methods, and algorithms described in the preceding sections may be embodied in, and fully or partially automated by, code modules executed by one or more computers, computer processors, or machines configured to execute computer instructions. The code modules may be stored on any type of non-transitory computer-readable medium or tangible computer storage device, such as hard drives, solid state memory, optical disc, and/or the like. The systems and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, is not generally intended to imply that features, elements and/or steps are required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present. The terms “about” or “approximate” and the like are synonymous and are used to indicate that the value modified by the term has an understood range associated with it, where the range can be ±20%, ±15%, =10%, =5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein.

What is claimed is:

1. An immersive display system comprising:
a master projector system comprising a master media server and a master projector, the master media server configured to:
generate a synchronization signal comprising a waveform encoding synchronization information;
transmit the synchronization signal over a first synchronization cable electrically coupled to the master projector system;
provide a master video; and
send the master video to the master projector for display;
a first slave projector system comprising a first slave media server and a first slave projector, the first slave media server configured to:
receive the synchronization signal from the master projector system over the first synchronization cable electrically coupled to the first slave projector system;
transmit the synchronization signal over a second synchronization cable electrically coupled to the first slave projector system;
extract the synchronization information;
provide a first slave video; and
send the first slave video to the first slave projector for display;
a second slave projector system comprising a second slave media server and a second slave projector, the second slave media server configured to:
receive the synchronization signal from the first slave projector system over the second synchronization cable electrically coupled to the second slave projector system;
extract the synchronization information;
provide a second slave video; and
send the second slave video to the second slave projector for display; and
a networked connection communicably coupling the master projector system to the first slave projector system and to the second slave projector system;
wherein the master video, the first slave video, and the second slave video are synchronized based at least in part on the synchronization information.

2. The immersive display system of claim 1, wherein the synchronization signal is encoded using a biphase mark code.

3. The immersive display system of claim 1, wherein the synchronization signal comprises a data word of 64 bits.

4. The immersive display system of claim 1, wherein the first and second synchronization cables are coaxial cables.

5. The immersive display system of claim 1, wherein a frame rate of each of the master video, the first slave video, and the second slave video is the same.

6. The immersive display system of claim 5, wherein the frame rate is 30 fps.

7. The immersive display system of claim 1, wherein the master video is extracted from a digital cinema package.

8. The immersive display system of claim 7, wherein the first slave video is extracted from the digital cinema package.

9. The immersive display system of claim 7, wherein the first slave video is extracted from a second digital cinema package.

10. The immersive display system of claim 7, wherein the second slave video is extracted from the digital cinema package.

11. The immersive display system of claim 1, further comprising a network connection communicably coupling the master projector system to the first slave projector system.

12. The immersive display system of claim 11, wherein the network connection further communicably couples the master projector system to the second slave projector system.

13. The immersive display system of claim 1, wherein a data rate of the synchronization signal is about 2 Mbps.

14. The immersive display system of claim 1, wherein a latency between the master video and the second slave video is less than 100 μs.

15. The immersive display system of claim 1, wherein a latency between the master video and the second slave video is less than 0.01% of a frame rate of the master video.

16. A slave projector system in an immersive display system, the slave projector system comprising:
a media module configured to provide a video comprising a plurality of video frames;
a synchronization in connector configured to receive a synchronization signal from a first synchronization cable electrically coupled to the synchronization in connector; and
a synchronization out connector electrically coupled to the synchronization in connector, the synchronization out connector configured to transmit the synchronization signal to a second synchronization cable electrically coupled to the synchronization out connector;
a synchronization module electrically coupled to the synchronization in connector, the synchronization module configured to
extract synchronization information from the received synchronization signal; and
provide the synchronization information to the media module,
wherein the media module provides a video frame of the video based at least in part on the synchronization information,
wherein the provided video frame is synchronized with a video of another projector system in the immersive display system.

17. The slave projector system of claim 16, wherein the synchronization in connector is electrically coupled to the synchronization out connector through active electronics.

18. The slave projector system of claim 16, further comprising a projector configured to display the provided video frame.

19. The slave projector system of claim 16, wherein the synchronization signal is formatted according to the AES3 standard.

20. The slave projector system of claim 16, wherein the media module is further configured to extract the video from a digital cinema package.

21. The slave projector system of claim 20, wherein at least a portion of the digital cinema package is stored on the slave projector system.

22. An immersive display system, comprising:
a server configured to store cinema content;
a server node connected to the server, wherein the server node is configured to receive the cinema content and to distribute the cinema content; and
a plurality of projector systems, each projector system comprising an integrated cinema media processor configured to receive the cinema content from the server node and to project a video based on the received cinema content,
wherein the plurality of projector systems comprise a master projector system and at least one slave projector system, the master projector system communicably coupled to the at least one slave projector system to transmit a synchronization signal to the at least one slave projector system thereby synchronizing video projected by the master projector system with video projected by the at least one slave projector system.

23. The immersive display system of claim 22, wherein the plurality of projector systems comprises the master projector system, a first slave projector system, and a second slave projector system, wherein the master projector system is connected by a first cable to the first slave projector system, and the first slave projector system is connected by a second cable to the second slave projector system, the first cable configured to transmit a synchronization signal from the master projector system to the first slave projector system, the second cable configured to transmit the synchronization signal from the first slave projector system to the second slave projector system.
